(19) United States
(12) Patent Application Publication
(10) Pub. No.: US 2022/0038856 A1
(43) Pub. Date: Feb. 3, 2022

(54) REMOTE SPEAKER MICROPHONE WITH TRACKING AND DISPLAY

(71) Applicant: OTTO ENGINEERING, INC., Carpentersville, IL (US)

(72) Inventor: Daniel Stanek, Chicago, IL (US)

(21) Appl. No.: 17/274,946

(22) PCT Filed: Sep. 11, 2019
(86) PCT No.: PCT/US2019/050609

§ 371 Date: Mar. 10, 2021

Related U.S. Application Data
(60) Provisional application No. 62/729,720, filed on Sep. 11, 2018.

(51) Int. Cl. H04W 4/029

(52) U.S. Cl. CPC H04W 4/029

(57) ABSTRACT

An apparatus and method comprising a remote speaker microphone that attaches to a portable land mobile radio utilized by first responders, police, fire, military and other law enforcement that incorporates an embedded electronic location tracking system and display for monitoring the location of other users that possess a similar system.

### INCORPORATION BY REFERENCE

The present application claims the benefit of U.S. Provisional Application Ser. No. 62/729,720, filed Sep. 11, 2018. The above-identified application is incorporated herein by reference in its entirety.

### BACKGROUND

Law enforcement, first responders, military personnel, border patrol agents, forestry rangers or even industrial end users utilize land-mobile radio devices or mobile phones to convey critical information to each other. Remote speaker microphones are often connected to these radios to facilitate audio communications. During emergency situations, it can often be difficult to find fellow agents, officers, soldiers or fire fighters because they are busy or physically unable to respond to radio requests or they may not know their exact location. First responders are beginning to use GPS-enabled devices to determine their location and help save lives during emergency situations. GPS-enabled devices can improve situational awareness for firefighters battling a large-scale fire. Tackling a large wildfire, for example, requires that firefighters be strategically positioned with real-time information about their locations relative to the fire. GPS-enabled devices can give that incident commander coordinating personnel the precise location information needed to effectively fight the fire.

For law enforcement, knowing exactly where assets and personnel are located while securing a large event is invaluable. When a call for help comes in, commanders can easily and quickly locate and dispatch the closest first responder using GPS-based apps. During a mass causality event, GPS can be used to monitor the location of ambulances in conjunction with a patient tracking system for a better understanding of the event and more efficient response.

Because of the increasing need within these markets to know each other's proximity for safety purposes or efficiency, there are multiple systems that can provide user location tracking capability. Some of these devices are simple GPS coordinate receivers that allow the user to determine their location, but require them to verbally communicate the coordinates to others if they want to inform others of their location. Some of these devices include a tracking transmitting device and a separate receiver or smart phone to identify the location of the transmitting device. These products rely on the cellular network to communicate coordinates between devices and therefore may not be functional in remote locations where cellular service is not available. To date, known location devices operate independently of the land mobile radio systems that users are required to carry. As a result, users often end up carrying multiple devices to maintain communications and determine their location.

### SUMMARY

The present disclosure relates generally to a remote speaker microphone (RSM) device that attaches to a communication device, such as two-way radio or mobile phone, and, more particularly, to a remote speaker microphone that incorporates an embedded electronic location tracking system to provide real-time determination of the RSM device's location acquired through the use of a Global Navigation Satellite System (GNSS), BLE Beacon, WiFi Access Point, Altimeter, Inertial navigation system (INS), or other suitable location identification technology and transmit it in near real-time, continuously or along with the user's audio, either embedded with the audio, or transmitted on a separate channel, to one or multiple receivers on the communication system that are equipped with a purpose-built circuitry, software, devices and visual displays designed to utilize the RSM device's location data to provide the receivers with the ability of determining the location of the RSM device.

The RSM device with tracking and communications circuitry may also include a visual display for the purpose of providing the RSM device's user with the ability to visually determine the location of other users of within the communications system that are equipped with similar devices containing circuitry that has the capability of determining and transmitting their location data. The display included within the RSM device may provide the user with the ability to visually determine the geographical direction of the other users relative to their location, even if the other user is visually obstructed (relative to the user) or located many miles away.

The RSM device may include circuitry that is programmed, configured or otherwise adapted to display the position of remote users relative to the RSM device's position. This circuitry may include inputs and display drivers to control and power the display as well as processors that decode the remote user's location data and take into account the RSM devices' own real-time location data, acquired through the use of a Global Navigation Satellite System (GNSS), BLE Beacon, WiFi Access Point, Altimeter, Inertial navigation system (INS), or other suitable location identification technology, as well as the RSM device' bearing, established by the direction that the RSM device is pointed to at the time.

The RSM device containing a visual display may provide the user with a visual prompt indicating the direction of other user's position relative to the RSM device's position. In addition to proving the other user's direction relative to the RSM device, the visual display may provide the user with information such the distance to, altitude of, and possibly the name of the other users.

Certain aspects of an embodiment of the present disclosure relate to remote speaker microphone (RSM) device used in land-mobile radio or telecommunications systems with a location module configured, structured, programmed, or otherwise adapted to identify its indoor or underground geographic location coordinates (geospatial location data) using BLE Beacons, WiFi Access Point, compass, altimeter, drone, Inertial Navigation System (INS), or other suitable indoor location identification technologies and the circuitry. The RSM device may also include a transmitting module configured, programmed or otherwise adapted to transmit the location data to another device or system for the purpose of location tracking.

Certain aspects of another embodiment of the present disclosure relate to a remote speaker microphone (RSM) device used in land-mobile radio or telecommunications systems with a location module configured, programmed or otherwise adapted to identify its outdoor geographic location coordinates (geospatial location data) or position using GPS, Global Navigation Satellite System (GNSS), outdoor BLE Beacon, WiFi Access Point, Altimeter, Inertial navigation system (INS), or other suitable location identification technologies. The RSM device may also include a transmitting module configured, programmed or otherwise adapted to transmit the location data to another device or system for the purpose of location tracking.

Certain aspects of yet another embodiment of the present disclosure relate to a remote speaker microphone (RSM) device used in land-mobile radio or telecommunications systems with a location module configured, programmed or otherwise adapted to identify its integrated circuity to identify its indoor, underground, or outdoor geographic location coordinates (geospatial data) or position using GPS, Global Navigation Satellite System (GNSS), BLE Beacons, WiFi Access Point, compass, altimeter, drone, Inertial Navigation System (INS), or other suitable location identification technologies. The RSM device may also include a transmitting module configured, programmed or otherwise adapted to transmit the location data to another device or system for the purpose of location tracking.

In each embodiment, the RSM device may transmit its location data separately from audio data that is transmitted through the land-mobile radio or telecommunications system.

Alternatively, the RSM device may encode its location data onto or with audio data that is transmitted through the land-mobile radio or telecommunications system.

In each embodiment, the location data may be continuously transmitted or it may transmitted only when the RSM device makes an audio transmission.

One or both of the users may be in motion or have the ability to easily move their physical location; therefore, the transmitted location data may be dynamic.

The transmitter's and receiver's physical locations may be dynamic and geospatial data may be relayed in real-time or near real-time.

In the event that either user is temporarily unable to establish their exact physical location their geospatial location may be temporarily estimated or simulated until they are able to re-establish their location and send geospatial data in real-time.

The transmitting module may also transmit its geospatial data at the beginning of the transmission instead of continuously broadcasting its geospatial data.

The transmitting module may also transmit its geospatial data at intervals during the transmission instead of continuously broadcasting its geospatial data.

In each embodiment, the RSM device may further include a visual display and circuity programmed, configured or otherwise adapted to receive, process and display location data of other RSM devices within the communications network that are transmitting their location data.

The display may include a directional indicator that can be used to determine the location of other users.

In some embodiments, the RSM device may include circuitry for extracting location data that was embedded with an audio signal and comparing the transmitter's location data against the receiver's physical location coordinates to establish relative altitude, distance, and direction from the transmitter to the receiver.

Certain aspects of the present disclosure relate to a communications system comprising a plurality of communication devices, where each communication device comprising a module, a display device and a processor. The location module may be structured, programmed, configured or otherwise adapted to identify its geographic location coordinates (location data). The processing module may be structured, programmed, configured or otherwise adapted to transmit the location data for the respective communication device to at least one other communication devices on the land-mobile radio system, receive location data from the at least one other communication; and process the location data and control the display device to display the relative location of the communication devices to one another.

In some embodiments, the processing module controls the display device to provide a visual indication of the relative altitude, distance, and/or direction between the communication devices.

In at least some embodiments, the location module determines the location data using BLE Beacons, WiFi Access Point, compass, altimeter, drone, and/or Inertial Navigation System (INS).

In some embodiments, the communication system is a land-mobile radio system and at least some of the communication devices comprise remote speaker microphone (RSM) devices.

### BRIEF DESCRIPTION OF THE DRAWINGS

FIG. 1 is a schematic illustration of a communication system according to certain aspects of the present disclosure

FIG. 2 depicts a RSM device according to certain aspects of the present disclosure.

FIG. 3 is a block diagram of an embodiment of a tracking unit.

FIGS. 4A to 4G illustrate embodiments of displays that may be employed in the remote speaker microphone.

### DETAILED DESCRIPTION

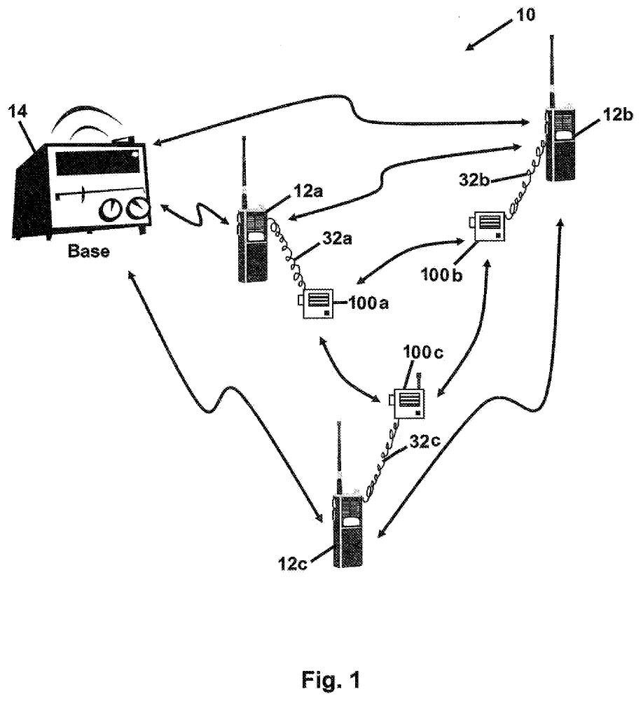

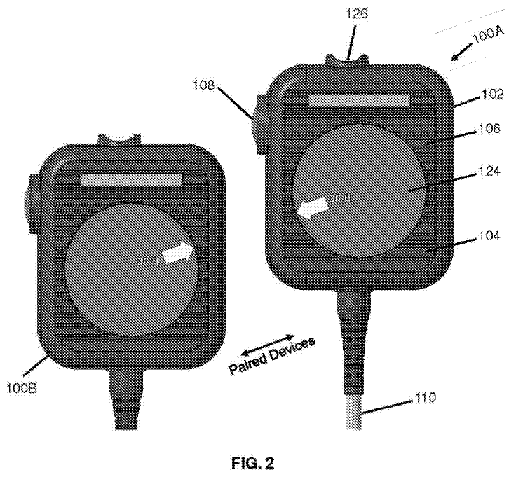

With reference to FIGS. 1 and 2, a communication system 10 according to certain aspects of the present disclosure includes a plurality of communication devices 12a-12c, such as conventional as push-to-talk (“PTT”) two-way radios. PTT radios are commercially available from a variety of companies, including Motorola, Kenwood, and ICOM. One suitable radio is a model HT1000 as is available from Motorola. The radios are all similar, so the description of the radio 12a applies to all of the radios 12a-12c. Further, while three radios are shown, it will be appreciated that fewer or more radios can be used without departing from the scope of the present disclosure. The PTT radio 12a is a microprocessor controlled transceiver device used for two-way radio frequency (RF) communication with other PTT radios and/or base stations 14. The radio 12a is capable of receiving voice through a microphone 16, and delivering a modulated RF signal to an antenna 18 for transmission. The transmitter of the radio 12a is activated when a PTT switch 20 is depressed. The radio 12a is also capable of receiving a modulated RF signal through the antenna 18, and delivering a demodulated audio signal to a speaker 22.

The user may interface with the radio 12a through a remote speaker microphone (RSM) device 100a. In the illustrated embodiment, the RSM device 100a is coupled to the radio 12a through a cable 32a. Alternatively, the RSM device 100a may be interconnected with the radio 12a through a wireless connection, such as a BlueTooth® connection.

The RSM device 100a includes an internal an embedded electronic location tracking system to provide real-time determination of the RSM's location acquired through the use of a Global Navigation Satellite System (GNSS), BLE Beacon, WiFi Access Point, Altimeter, Inertial navigation system (INS), or other suitable location identification technology and transmit it in near real-time, continuously or along with the user's audio, either embedded with the audio, or transmitted on a separate channel, to one or multiple receivers on the communication system that are equipped with a purpose-built circuitry, software, devices and visual displays designed to utilize the RSM device's location data to provide the receivers with the ability of determining the location of the RSM device.

The RSM device with tracking and communications circuitry may also include a visual display for the purpose of providing the RSM device's user with the ability to visually determine the location of other users of within the communications system that are equipped with similar devices containing circuitry that has the capability of determining and transmitting their location data. The display included within the RSM device may provide the user with the ability to visually determine the geographical direction of the other users relative to their location, even if the other user is visually obstructed (relative to the user) or located many miles away.

The RSM device may include circuitry that is programmed, configured or otherwise adapted to display the position of remote users relative to the RSM device's position. This circuitry may include inputs and display drivers to control and power the display as well as processors that decode the remote user's location data and take into account the RSM devices' own real-time location data, acquired through the use of a Global Navigation Satellite System (GNSS), BLE Beacon, WiFi Access Point, Altimeter, Inertial navigation system (INS), or other suitable location identification technology, as well as the RSM device' bearing, established by the direction that the RSM device is pointed to at the time.

The RSM device containing a visual display may provide the user with a visual prompt to indicate the direction of other user's position relative to the RSM device's position. In addition to proving the other user's direction relative to the RSM device, the visual display may provide the RSM device user with information such the distance to, altitude of, and possibly the name of the other users.

FIG. 2 illustrates a pair of remote speaker microphones 100a, 100b according to an embodiment of the present disclosure. Since the remote speaker microphones 100a, 100b have identical construction, only one will be described in detail. The remote speaker microphone 100a is configured to interface with a communication device such as a two-way radio (as shown in FIG. 1). In general, the remote speaker microphone 100a includes a housing 102 that supports a microphone 104, a speaker 106, a push-to-talk (“PTT”) button 108, and internal circuitry (not shown) for interfacing with the communication device. A cable 110 extends from housing 102 for interconnecting the remote speaker microphone 100a with the communication device. Connectors (not shown) may also be provided for an optional antenna and/or detachable in-ear speaker. In some embodiments, the remote speaker microphone 100a may also include a replaceable or rechargeable battery, an amplifier circuit, a microphone noise reduction circuit or wireless (Bluetooth) circuit for connecting with other devices. The general operation of a remote speaker microphone is well understood in the art and, accordingly, will not be described in detail herein.

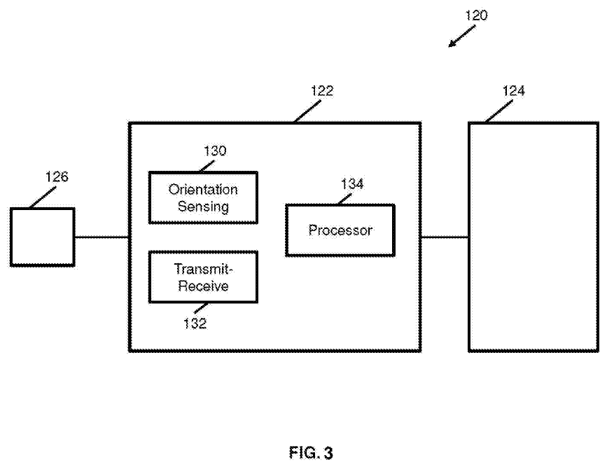

With further reference to FIG. 3, the remote speaker microphone 100 also includes an embedded electronic location tracking and communicating unit 120. The embedded electronic location tracking and communication unit may also include a controller 122 and a display 124. The controller 122 operates the display 124 to convey location information (e.g., direction and distance) of one or more other tracking units. The display may also communicate information including name or other identifier, mobility status such as in motion or standing still, last known location, etc. In some embodiments, the display may simultaneously display the location of multiple tracking units at one time. The tracking unit 120 may also include a pairing button 126 to facilitate pairing of the tracking unit 120 with the tracking unit(s) from other devices, such as another remote speaker microphone 100B.

The controller 122 may include an orientation sensing module 130, a transmit-receive module 132, and a processing module 134. The orientation sensing module 130 may use a variety of locating technologies such as GPS technology, solid state gyroscopes, multidirectional solid state accelerometers, wireless signal triangulation methods, and/or other suitable technology, to determine a location of the user in proximity to other users with similar tracking devices. The transmit-receive component 132 may operate at a suitable frequency (such as 900 MHz, 2.4 Ghz, etc.) to package the location data and intermittently or constantly transmit it directly to other similar devices. The transmit-receive module 132 is also configured to detect and receives similar location data from other similar tracking devices. The processing module 134 in turn is configured to process the data received from orientation sensing module 130 and transmit-receive module 132 to and utilize this data to determine the user's location relative to other users or critical marked locations. The processing module 134 is further configured to operate the display unit 124 to convey information concerning the user's location (e.g., direction and/or distance) relative to other users or locations.

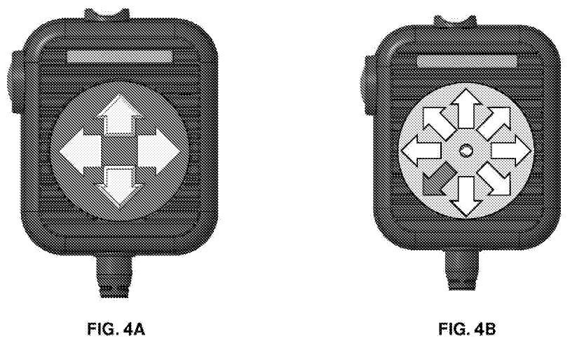

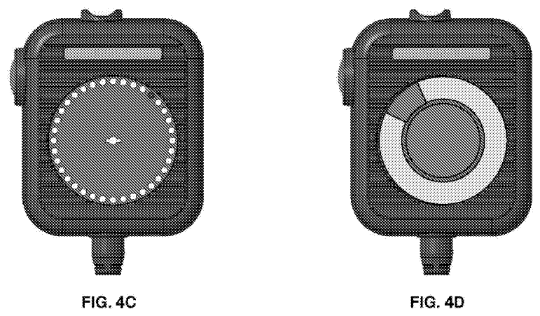

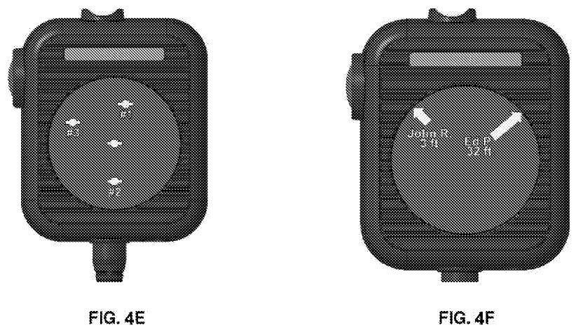

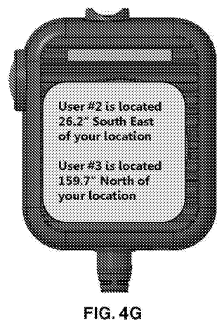

As is illustrated in FIGS. 4A-4G, a variety of techniques and technologies may be used to display the location information to the use. Examples include directional arrows (see, e.g., FIGS. 2, 4A, 4B, and 4F), LED's or other lights for a simple directional arrow indicator of the other user's location or a more detailed display utilizing liquid crystal or electronic ink technology that may be programmed to graphically communicate their location or provide notification that they have exceeded a pre-determined distance away from the user.

In FIGS. 4A and 4B the display includes a plurality of directional arrows (4 in FIG. 4A and 8 in FIG. 4B) that are used to indicate the location of the user relative to other users with tracking units. The user's location may be situationally positioned in the center of the array of arrows with the arrows being arranged to point outward from the center. The arrow corresponding to the directional location of another user with a tracking unit is activated (lighted) to communicate the direction of their location with respect to the user.

FIG. 4C illustrates an embodiment of the display 124 that uses a series of lights (e.g., LEDs) fashioned in a circular pattern to indicate the user's location with respect to other users that have tracking systems. The user is positioned in the center and the lights are arranged in a circle around the center. In operation, the light that most closely corresponds to the direction of the other user is illuminated to indicate their direction. FIG. 4D illustrates another embodiment that uses a lighted area to indicate the direction of another user.

In some embodiments, the tracking unit may process location data from multiple users and display their locations with respect to the primary user's location. FIGS. 4E to 4G are exemplary embodiments of displays that can be used to indicate the direction and distance of multiple users relative to one another. As will be appreciated, the display unit may use combinations of the illustrated display techniques as well as other techniques to provide the desired location information. For example, as shown, in FIG. 4C, the user is positioned in the center of the display and distance to the other user's on the network.

In FIG. 4F, the primary user is again positioned in the center of the display, while arrows and text are used to indicate the direction and distance, respectively, of the other users.

In the embodiment of FIG. 4G, the display provides a written indication of the location of the other users, e.g., “user #2 is located 26.2 feet South East of your location.”

In other embodiments, a liquid crystal or electronic ink display, for example, may be used to visually communicate the location of other users with a tracking system by showing an arrow, icon or some other marker that denoted their general direction with respect to the user.

1. A remote speaker microphone (RSM) device used in land-mobile radio or telecommunications systems comprising:
a location tracking system configured to identify geographic location coordinates using one or more of GPS, Global Navigation Satellite System (GNSS), BLE Beacons, WiFi Access Point, compass, altimeter, drone, or Inertial Navigation System (INS), wherein the geographic location coordinates are one or more of indoor, underground, or outdoor geographic location coordinates;
a transmitter configured to transmit the geographic location coordinates to another device or system configured to perform location tracking;
a display device; and
a processor configured to:
receive location data from other RSM devices within a communications network that are transmitting respective location data, and
control the display device to display a relative location of each of the other RSM devices.

2-3. (canceled)

4. The RSM device of claim 1, wherein the geographic location coordinates are transmitted separately from audio that is transmitted through the land-mobile radio or telecommunications system.

5. The RSM device of claim 1, wherein the geographic location coordinates are encoded with audio that is transmitted through the land-mobile radio or telecommunications system.

6. The RSM device of claim 1, wherein the geographic location coordinates are continuously transmitted by the RSM device.

7. The RSM device of claim 1, wherein the geographic location coordinates are only transmitted during audio transmissions by the RSM device.

8. The RSM device of claim 1, wherein the RSM device is movable during use and the geographic location coordinates are dynamic.

9. The RSM device of claim 1, wherein the RSM device is a hand-held, portable device.

10. The RSM device of claim 1, wherein the geographic location coordinates are determined and transmitted in real-time or near real-time.

11. The RSM device of claim 1, wherein the geographic location coordinates are temporarily estimated or simulated when actual geographic location coordinates cannot be determined.

12. The RSM device of claim 1, wherein the geographic location coordinates are only transmitted at the beginning of an audio transmission.

13. The RSM device of claim 1, wherein the geographic location coordinates are transmitted at intervals during an audio transmission.

14. (canceled)

15. The RSM device of claim 1, wherein the display device is configured to present a directional indicator that visually identifies the relative location of each of the RSM devices.

16. The RSM device of claim 1, wherein the display device is controlled to provide a visual indication of a relative altitude, distance, and/or direction from the RSM device to at least one of the other RSM devices.

17. A communications system comprising a plurality of communication devices, each communication device comprising:
a location tracking system configured to identify geographic location coordinates;
a display device; and
a processor configured to:
transmit, via a transmitter, the geographic location coordinates for the respective communication device to at least one other of the plurality of communication devices;
receive, via a receiver, location data from the at least one other of the plurality of communication devices; and
c. process the location data and control the display device to display a relative location of the at least one other of the plurality of communication device with respect to the respective communication devices.

18. The communications system of claim 17, wherein the processor is configured to control the display device to provide a visual indication of the relative altitude, distance, and/or direction between the respective communication device and the at least one other of the plurality of communication devices.

19. The communication system of claim 17, wherein the location tracking system is configured to determine the geographic location coordinates location data using BLE Beacons, WiFi Access Point, compass, altimeter, drone, and/or Inertial Navigation System (INS).

20. The communication system of claim 17, wherein the communication system is a land-mobile radio system and at least some of the plurality of communication devices comprise remote speaker microphone (RSM) devices.

21. The communication system of claim 17, wherein the geographic location coordinates comprises any of indoor, underground, or outdoor geographic location coordinates of the respective communication device.
